(19) United States
(12) Patent Application Publication
(10) Pub. No.: US 2025/0059806 A1
(43) Pub. Date: Feb. 20, 2025

(54) EMERGENCY DEVICE FOR A STORAGE COMPARTMENT OF A VEHICLE AND CONTROL METHOD

(71) Applicant: Brose Schliesssysteme GmbH & Co. Kommanditgesellschaft, Wuppertal (DE)

(72) Inventors: Christian GITTER, Zeil am Main (DE); Thomas GOLDMANN, Bayreuth (DE); Björn FÜRST-NEUENDORF, Hallstadt (DE); Markus ROSENTHAL, Bamberg (DE)

(21) Appl. No.: 18/801,132

(22) Filed: Aug. 12, 2024

(30) Foreign Application Priority Data
Aug. 14, 2023 (DE) 10 2023 121 784.4

(51) Int. Cl. E05B 83/26; B60H 1/00; B60Q 1/52; B60Q 5/00

(52) U.S. Cl. CPC E05B 83/26; B60H 1/00657; B60Q 1/52; B60Q 5/005

(57) ABSTRACT

It is provided an emergency device for a vehicle, comprising an actuation element for attachment in a storage compartment of the vehicle, which is closable by at least one closure element, and an electronic control unit, wherein the actuation element is provided for signaling an emergency by a person located in the closed storage compartment, and the electronic control unit is configured for generating at least one emergency signal in response to an actuation of the actuation element. The electronic control unit is further configured to trigger a ventilation measure in response to an actuation of the actuation element, via which additional air enters the storage compartment that is still closed by the at least one closure element.

### BACKGROUND

The proposed solution relates to an emergency device for a vehicle, and a method for controlling an emergency device on a vehicle.

Vehicles may have a storage compartment both at the rear and underneath at the front, which storage compartment is closable by at least one closure element. For example, in the case of a rear storage compartment, a closure element is formed by a tailgate or boot lid. In the case of a front storage compartment, which, in the case of electric vehicles, is also referred to as a “frunk”, a closure element is formed by a front hood. Since a person, in particular a child, can also be locked in a storage compartment of this kind, it is known to arrange an actuation element for signaling an emergency in the vehicle-side storage compartment.

If a person is locked in the storage compartment that is closed by the at least one closure element, the person can generate an emergency signal via the actuation element which is accessible inside the storage compartment. This emergency signal triggers an emergency measure, such as making an emergency call to an emergency call receiving point. Making an emergency call allows a person who cannot, alone, free themselves from the storage compartment, to call attention to themselves inside the closed storage compartment and to for example provide information on their location via a voice connection to the emergency call receiving point, or to transmit an alarm via a silent emergency call, specifying GPS data.

Alternatively, it is known to trigger an emergency signal via an actuation element in the interior of a rear storage compartment, via which emergency signal unlocking of the at least one closure element from the inside can be triggered as the emergency measure, and as a result the closure element can be adjusted into an open position. However, in the case of a storage compartment that is provided on a front side of a vehicle, but also at the rear, corresponding opening of at least one closure element, in particular during travel of the vehicle, may entail significant potential danger. In particular for what are known as frunks, additional safety measures are therefore required in the event of a person locked therein.

### SUMMARY

Against this background, the proposed solution addresses the problem of providing an emergency device and a controller for an emergency device for a vehicle, by means of which the above-mentioned disadvantages can be at least reduced.

This problem is solved an emergency device with features as described herein.

In this case, a proposed emergency device comprises an electronic control unit which can generate at least one emergency signal for an emergency measure in response to an actuation of an actuation element accessible in the interior of a vehicle-side storage compartment. In this case, the electronic control device is additionally configured to trigger a ventilation measure in response to an actuation of the actuation element, via which additional air enters the storage compartment that is still closed by the at least one closure element.

By means of a proposed emergency device it is thus possible, before, after or at the same time as generating an emergency signal for an emergency measure, to allow additional air to flow into the storage compartment, still closed by the at least one closure element, in an electronically controlled manner, via a ventilation measure. In this way, the physical integrity of a person shut in the storage compartment can be ensured, without it being necessary to immediately fully open the at least one closure element, the opening of which, possibly on account of the current travel state of the vehicle, is associated with additional potential danger.

For example, the electronic control unit of the emergency device can be configured to actuate a ventilation device for the ventilation measure, via which device additional air is introduced into the storage compartment. This for example includes a ventilation opening being released in an electronically controlled manner, in order to allow air from outside to flow into the storage compartment, for example via a covering of an air supply leading into the storage compartment, which is adjustable independently of the closure element. Alternatively, or in addition, at least one fan may be activatable via the electronic control unit, in order to actively convey additional air into the storage compartment, when the actuation element accessible in the interior of the storage compartment has been actuated.

In a variant, it can alternatively or additionally be provided that the at least one closure element is held in a closed position by a lock and the electronic control device is configured to actuate the lock, for the ventilation measure, in order to allow for an adjustment of the at least one closure element out of the closed position along an opening direction into a pre-latching position. In said pre-latching position, although the at least one closure element still closes the storage compartment and is thus held in an at least partially closed position, at least one gap is released via the closure element that is in the pre-latching position, via which gap additional air can enter the storage compartment. Consequently, in a variant of this kind, the actuation of the actuation element does not immediately provide complete opening of the closure element. Rather, for example on account of a spring loading in the opening direction, the closure element is released for an adjustment only to such an extent that the closure element assumes the pre-latching position, in which the closure element still remains blocked against further adjustment in the opening direction by the at least one lock.

In principle, the control device can be configured to make the triggering of the ventilation measure dependent on at least one speed signal which is indicative of a travel speed of the vehicle. This for example includes the possibility that the ventilation measure is triggered only if a travel speed of the vehicle has reached a threshold value. Thus, for example, a—possibly first—actuation of the actuation element makes it possible to achieve only additional air entering the closed storage compartment when the vehicle is already or still travelling at a travel speed above the threshold value. In this case, immediate complete opening of the storage compartment may entail an additional potential danger for a person located therein. Likewise, immediate opening of the storage compartment may be dangerous for other road users, in particular if it is a front storage compartment and a front hood were to be opened fully immediately, when the vehicle is travelling. This can be prevented in the explained variants.

In particular in this connection, it can also be provided that the control device is configured to actuate the lock, by means of which the at least one closure element is locked in a closed position, to release the at least one closure element, when the travel speed of the vehicle is below the threshold value. In this case, the actuation of the lock takes place in order to allow for an adjustment of the at least one closure element out of the closed position along the opening direction into an opening position, in which the at least one closure element no longer closes the storage compartment, but only if the travel speed of the vehicle has not reached the threshold value. Thus, depending on the travel speed of the vehicle and by means of the at least one speed signal evaluated for this purpose by the control device, upon actuation of the actuation element in the interior of the closed storage compartment either the ventilation measure is triggered (if the vehicle is moving at a travel speed above a threshold value) or the closure element is immediately adjusted into its open position (if the vehicle is moving at a travel speed below the threshold value or is stationary).

In an alternative variant, upon actuation of the actuation element the ventilation measure is always triggered first, and a decision regarding possible complete opening of the at least one closure element is made only in response to a subsequent further actuation of the actuation element. For this purpose, the electronic control device is configured for example to trigger the ventilation measure in response to a first actuation of the actuation element, and to generate the at least one emergency signal (for the emergency measure following the ventilation measure) only in response to a subsequent second actuation of the actuation element.

An emergency measure of this kind can then for example include actuation of a lock, such that the lock is actuated to release the locking of the closure element held in the closed position. In this case, the actuation of the lock in response to a second actuation of the actuation element can still be dependent on at least one speed signal which is indicative of a travel speed of the vehicle. Thus, for the triggering of the emergency signal, and in this case in particular complete opening of the at least one closure element, an (optionally repeated) speed check can take place, in order to decide whether the at least one closure element may actually be adjusted into an open position. This includes, in conjunction with the above such variants, the possibility that after a first actuation of the actuation element for example only the ventilation measure is triggered, because the travel speed of the vehicle is (still) too high. If, however, upon the second actuation of the actuation element the travel speed has then fallen below the threshold value, the at least one closure element can be released and maximally opened. Alternatively, the speed test takes place exclusively after a repeated, second actuation of the actuation element.

The at least one emergency signal can alternatively or additionally be provided for triggering other emergency measures. For example, the at least one emergency signal may be provided for transmitting an emergency call, in particular a silent emergency call or an emergency call in which a voice connection to an emergency call receiving point is provided. In a variant, the at least one emergency signal can alternatively or additionally be provided for generating an alarm that is acoustically and/or visually perceptible by a person in the surroundings of the vehicle. This includes for example the possibility that a vehicle horn and/or hazard lights are activated by the emergency signal, in order to indicate a position locked in the storage compartment. Alternatively, or in addition, the at least one emergency signal can be provided for influencing the current driving behavior of the vehicle. Thus, on the basis of the generated emergency signal, for example purposeful braking of the travelling vehicle can be triggered, in particular in the case of an at least partially autonomously or fully autonomously driving vehicle. In this case, the steering of the vehicle can be influenced electronically on the basis of the emergency signal, such that the vehicle is automatically steered to an edge of a road or to a carpark or another parking place and brought to a standstill when a person locked in the storage compartment has indicated their emergency situation by actuating the actuation element inside the storage compartment.

In this case, influencing of the current driving behavior of the vehicle can be dependent on an emergency call receiving point verifying the actual emergency situation and thus having approved and/or controlling the influence on the driving behavior of the vehicle.

As already explained above, the emergency device can be provided in particular for a storage compartment on a front side of the vehicle. This thus includes in particular the possibility that the emergency device is provided for what is known as a frunk on an electric vehicle. In this case, a closure element is formed for example by a front hood on the vehicle front. However, a proposed emergency device can in principle also be used on a rear car boot.

The proposed solution furthermore also relates to a vehicle, in particular an electric vehicle, comprising a variant of a proposed emergency device.

A variant of a vehicle of this kind consequently comprises the storage compartment closed by the at least one closure element, and the closure element that is held in a closed position by a lock of the vehicle. In this case, the lock can be actuatable via the electronic control unit of the emergency device.

Further, a radio interface can be provided on the vehicle side, via which a control signal can be received wirelessly from an emergency call receiving point, via which the lock is alternatively or additionally actuatable for releasing the at least one closure element, in order to allow for an adjustment of the at least one closure element out of a closed position along an opening direction and into a (maximally possible) open position, in which the at least one closure element no longer closes the storage compartment. Thus, on a corresponding vehicle the lock can also be actuatable remotely via the emergency device, specifically in response to the at least one emergency signal.

The proposed solution further relates to a method for controlling an emergency device on a vehicle. In this case, it is provided, for a proposed method, that an emergency is signaled by a person located in the closed storage compartment by actuation of an actuation element which is provided in the interior of the storage compartment closed by the at least one closure element, and in response to the actuation of the actuation element at least one emergency signal is generated. In response to an actuation of the actuation element, in the context of a proposed method a ventilation measure is triggered, via which additional air enters the storage compartment that is still closed by the at least one closure element.

A variant of a proposed method can therefore be implemented by using a variant of a proposed emergency device. Features and advantages explained above and below, of variants of a proposed emergency device therefore also apply to variants of a proposed control method, and vice versa.

In a variant of a proposed method it can for example be provided that in response to the at least one emergency signal at least one control signal is received from an emergency call receiving point, via which the lock is actuated for releasing the at least one closure element, in order to allow for an adjustment of the at least one closure element out of a closed position along an opening direction and into an open position, in which the at least one closure element no longer closes the storage compartment. In this connection, it can for example also be provided that, upon a first actuation of the actuation element (if the vehicle is not travelling or the travelling vehicle does not exceed a threshold value for the travel speed) a ventilation measure is triggered, for example in that a ventilation device is electronically actuated and/or the at least one closure element assumes a pre-latching position. Upon a further, second actuation of the actuation element, the emergency signal can then serve for contacting an emergency call receiving point, which remotely fully opens the closure element, in contact with the person locked in the storage compartment, after the emergency situation has been verified.

### BRIEF DESCRIPTION OF THE DRAWINGS

The accompanying drawings illustrate, by way of example, possible variants of the proposed solution.

FIG. 1 is a detail view of a vehicle comprising a variant of a proposed emergency device for a front storage compartment of the vehicle.

FIG. 2 is a flow diagram for a variant of a proposed control method.

### DETAILED DESCRIPTION

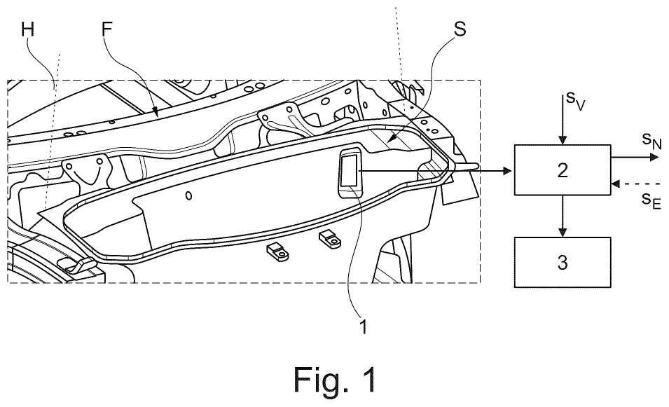

FIG. 1 is a detail view showing a vehicle F having a front storage compartment S which, in the case of electric vehicles, is typically also referred to as a “frunk”. The storage compartment S is closable by a closure element in the form of a pivotably mounted front hood H. In the open state of the front hood H, the interior of the storage compartment S is accessible. If, in contrast, the front hood H is closed and is thus present in a closed position, the front hood H can be locked by a lock 3, such that the front hood H cannot be opened without actuating the lock 3.

In the case of the vehicle F shown, the storage compartment S is dimensioned, in the present case, such that a person, in particular a child, could be accommodated in the storage compartment S and could thus be locked in inadvertently, e.g. on account of the folding-back front hood H. In order to be able to call attention to oneself and/or to be able to free oneself from the interior of the storage compartment S in an emergency of this kind, an actuation element in the form of an emergency button 1 is arranged in the interior of the storage compartment S. The emergency button 1 is coupled to an electronic control unit 2 (e.g. in the form of a controller) of an emergency device comprising the emergency button 1. Actuation of the actuation element 1, which, for this purpose, comprises an adjustable button or a touch panel for example, sends an actuation signal to the electronic control unit 2.

In principle, an emergency signal s_{N} can already be triggered, via the electronic control unit 2, directly in response to such a (first) actuation of the emergency button 1. For example, an emergency signal s_{N} of this kind is provided for transmitting an emergency call. Accordingly, a person located in the storage compartment S can contact an emergency call receiving point, if required, by actuating the emergency button 1, in order to thereby provide information about their emergency situation and seek help.

The at least one emergency signal s_{N} can alternatively or additionally be provided for generating an alarm that is acoustically and/or visually perceptible by a person in the surroundings of the vehicle F.

Optionally, a current driving behavior of the vehicle F can also be influenced by the generated emergency signal s_{N}, for example in order to purposely brake the vehicle F and optionally bring it purposely to a standstill at a roadside, in a parking space, or on another parking area.

In the present case, it is provided that a first actuation of the emergency button 1 does not immediately trigger the generation of the emergency signal s_{N}. Rather, the emergency device shown implements an at least two-stage process, in order to reduce the potential of danger both for a person locked in the storage compartment S and also for other road users in the surroundings of the vehicle 11, as well as to allow a person locked in the storage compartment S to be released from the storage compartment S in a more reliable and injury-free manner.

In the case of the emergency device shown, it is provided for this purpose for example that initially a current travel speed of the vehicle F is checked, in response to a first actuation of the emergency button 1. For this purpose, the electronic control unit 2 evaluates a speed signal s_{V} which is indicative of the current travel speed of the vehicle F. If it is signaled, for example via the speed signal s_{V}, that a current travel speed of the vehicle F is below a stored threshold value of for example 5 km/h, the electronic control unit 2 directly actuates the lock 3 in order to release a locking of the front hood H that is present in a closed position. The front hood H that is resiliently preloaded in the direction of an opening position by at least one spring element is then adjusted automatically by the lock 3 into the maximally possible open position, after release of the locking, in which position the storage compartment S is released. A person located in the storage compartment S can thus be released from the storage compartment S immediately, by actuating the emergency button 1 once.

If, however, the speed signal s_{V} signals that the vehicle F is already travelling at a higher speed, automatic opening of the front hood H to a maximum possible opening position may result in endangering further road users and also the person located in the storage compartment S. For example, the maximally opened front hood H may significantly restrict the field of view for a driver of the vehicle F. Furthermore, climbing out of the storage compartment S is under some circumstances very dangerous for a person located in the storage compartment S, when the vehicle is travelling.

If, accordingly, the electronic control unit 2 determines, following a first actuation of the emergency button 1, on the basis of the speed signal s_{V}, that the current travel speed of the vehicle F has reached or even exceeds a threshold value, the electronic control unit 2 initially merely triggers a ventilation measure, in order to make additional air available for a person located in the storage compartment S, in order to ensure the physical integrity of the person located in the storage compartment S.

A ventilation measure of this kind may for example include a ventilation device being electronically actuated by the electronic control unit 2, in order to allow additional air to flow into the storage compartment S. For example, it may be provided, in this connection, that one or more ventilation openings into the storage compartment S are opened, and/or one or more fans are activated, for blowing additional air into the storage compartment S. Alternatively or in addition, the lock 3 can be actuated by the electronic control unit 2, in order to allow for an adjustment of the front hood H into a pre-latching position. Consequently, such actuation of the lock 3 releases the locking of the front hood H via the lock 3 only in part, such that the front hood H is adjusted from a fully shut closed position into a pre-latching position in which at least one gap is released by the front hood H, via which gap air can flow into the storage compartment S. Thus, in the pre-latching position, the storage compartment S is still closed by the front hood H. However, the front hood H is held in a position, by the lock 3, in which air can flow into the storage compartment S from the outside, via one or more gaps between a top of a wall that bounds the storage compartment S, and the front hood H. In this case, in the pre-latching position the front hood H remains locked in the partially closed pre-latching position via a locking element of the lock 3 in the form of a pre-catch.

If, following the triggered ventilation measure, the emergency button 1 is actuated again, and thus at least a second time, by a person located in the storage compartment S, the emergency signal s_{N} is generated. Said emergency signal s_{N} can now in particular lead to
an emergency call being transmitted to an emergency call receiving point, and/or
a vehicle horn and/or hazard lights of the vehicle F being activated, in order to indicate acoustically and/or visually in and/or on the vehicle F that there is a person located in the storage compartment S, and/or
a current driving behavior of the vehicle F being influenced in such a way that the vehicle F is purposely braked and steered to a possible stopping place.

In this case, a transmitted emergency call can in principle be a silent emergency call transmitting GPS data, in order to indicate a current position of the vehicle F in which a person is locked in the storage compartment S. However, in the present case an emergency call is in particular understood to be an emergency call to an emergency call receiving point, establishing a voice connection, in order to allow a person located in the storage compartment S to communicate with the emergency call receiving point via at least one microphone and one loudspeaker in said storage compartment.

In particular in the latter case, it can also be provided that the electronic control unit 2 can receive at least one control signal s_{E} from the emergency call receiving point, from the emergency call receiving point and via a receiving interface of the vehicle F that is connected to the electronic control unit 2. The at least one control signal s_{E} then signals to the electronic control unit 2 or directly to the electronically controllable lock 3 that the locking of the front hood H can be fully released, and thus the front hood can be adjusted or is automatically adjusted out of the pre-latching position into the maximally possible open position. In this case, the at least one control signal s_{E} for complete release of the front hood H is for example generated and sent to the vehicle F from a spatially remote emergency call receiving point only if an emergency for a person located in the storage compartment S has actually been verified, and it is optionally also ensured that the vehicle F has virtually or completely come to a standstill.

The at least one received control signal s_{E} can alternatively also lead to an electronic barrier for unlocking of the lock 3 to be switched to be inactive. While in the case of an active barrier a further actuation of the emergency button 1 does not lead to complete unlocking of the lock 3 and thus adjustability of the front hood H into the maximally opened open position, this is made possible in the case of an electronic barrier that is switched to be inactive. A person located in the storage compartment S can thus trigger complete unlocking of the front hood H only following receipt of the at least one control signal s_{E} at the vehicle F via a repeated actuation of the emergency button 1.

In another scenario, a second actuation of the emergency button 1 can optionally also be omitted. It can also be provided that, following a one-time actuation of the emergency button 1, depending on the speed signal s_{V}, in the case of a travelling vehicle F the ventilation measure is always triggered first, and thus for example the front hood H is adjusted into a pre-latching position. Furthermore, the emergency signal s_{N} is generated, via which an emergency call is transmitted to an emergency call receiving point. If, subsequently, optionally by discussion with the person located in the storage compartment S, it is then verified by the emergency call receiving point that there is actually an emergency at the vehicle F, the at least one control signal s_{E} is transmitted to the vehicle F in order to allow or trigger full opening of the front hood H.

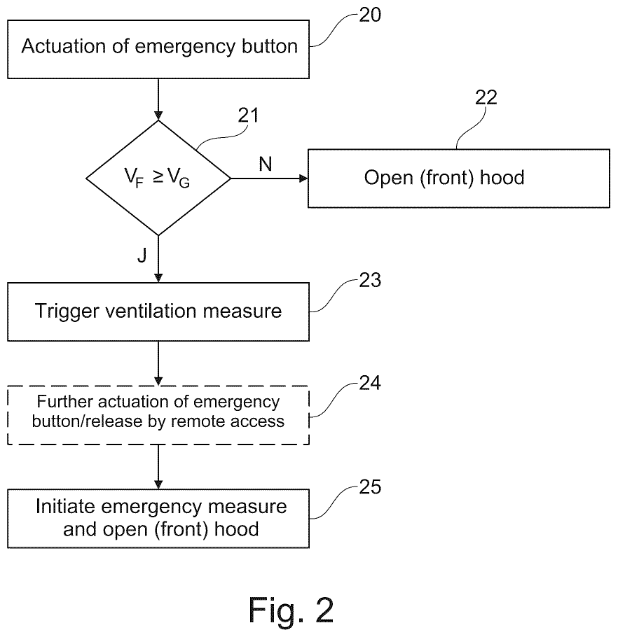

FIG. 2 illustrates, on the basis of the above explanations, a possible variant of a proposed control method for an emergency device on the vehicle F.

In the case of the method illustrated in FIG. 2, it is firstly provided, in a first step 20, that a person located in the storage compartment S actuates the emergency call button 1 for the first time. In response to this, firstly, in a subsequent step 21, a check is made as to whether a travel speed v_{F} of the vehicle F, signaled via the speed signal s_{V}, corresponds to or exceeds a speed threshold value V_{G} stored in a memory of the electronic control unit 2. If the current travel speed V_{F} is less than the stored threshold value V_{G} for the travel speed, in a method step 23 the lock 3 is electronically actuated by the control unit 2, and thus the front hood H is released for adjustment into a maximally opened open position. In contrast, in a method step 23, first merely triggering of a ventilation measure is provided if the vehicle F is travelling too fast.

In the case of a vehicle F that is travelling too fast, an at least two-step process is provided, in order to allow a person located in the storage compartment S to climb out of the storage compartment S. In this case, triggering of the ventilation measure first ensures, in a first step, that the person in the storage compartment S has sufficient air available. In the following, in a further step, e.g. in a further method step 25 according to FIG. 2, it ca be provided that an emergency measure is initiated and for example an emergency call is transmitted to an emergency call receiving point. Only when at least one further criterion is met is the front hood H then released via the lock 3 and fully opened, for example by transmitting at least one control signal s_{E} and/or after an acoustic and/or visual alarm has been triggered in and/or on the vehicle F and/or the vehicle F has come to a standstill.

In a possible development, as explained above, in addition a further actuation of the emergency call button 1 in the storage compartment S and/or a release of the lock 3 via remote access and thus via at least one control signal s_{E} sent from an emergency call receiving point is necessary between the triggering of the ventilation measure in method step 23 and the initiation of the emergency measure in a method step 24 of FIG. 2.

### LIST OF REFERENCE SIGNS

1 emergency button (actuation element)
2 control unit
3 lock system
4 ventilation device
F vehicle
H front hood (closure element)
S storage compartment/frunk
s_{E} control signal
s_{N} emergency signal
s_{V} speed signal

1. An emergency device for a vehicle, comprising
an actuation element for attachment in a storage compartment of the vehicle, which is closable by at least one closure element, and
an electronic control unit,
wherein the actuation element is provided for signaling an emergency by a person located in the closed storage compartment, and the electronic control unit is configured for generating at least one emergency signal in response to an actuation of the actuation element,
wherein the electronic control unit is configured to trigger a ventilation measure in response to an actuation of the actuation element, via which additional air enters the storage compartment that is still closed by the at least one closure element.

2. The emergency device according to claim 1, wherein the electronic control unit is configured to actuate a ventilation device for the ventilation measure, via which device additional air is introduced into the storage compartment.

3. The emergency device according to claim 1, wherein the at least one closure element is held in a closed position by a lock and the electronic control device is configured to actuate the lock for the ventilation measure, in order to allow for an adjustment of the at least one closure element out of the closed position along an opening direction into a pre-latching position, in which the at least one closure element still closes the storage compartment but releases at least one gap, via which additional air can enter the storage compartment.

4. The emergency device according to claim 1, wherein the control device is configured to make the triggering of the ventilation measure dependent on at least one speed signal, which is indicative of a travel speed of the vehicle.

5. The emergency device according to claim 4, wherein the control device is configured to trigger the ventilation measure only if a travel speed of the vehicle has reached a threshold value.

6. The emergency device according to claim 3, wherein the control device is configured to make the triggering of the ventilation measure dependent on at least one speed signal, which is indicative of a travel speed, wherein the control device is configured to trigger the ventilation measure only if a travel speed of the vehicle has reached a threshold value of the vehicle, wherein the control device is configured to actuate the lock to release the at least one closure element, in order to allow for an adjustment of the at least one closure element out of the closed position along the opening direction into an opening position, in which the at least one closure element no longer closes the storage compartment if the travel speed of the vehicle has not reached the threshold value.

7. The emergency device according to claim 1, wherein the electronic control unit is configured to trigger the ventilation measure in response to a first actuation of the actuation element and to generate the at least one emergency signal only in response to a subsequent second actuation of the actuation element.

8. The emergency device according to claim 7, wherein the control unit is configured, in response to a second actuation of the actuation element, to make the generation of the emergency signal dependent on at least one speed signal which is indicative of a travel speed of the vehicle.

9. The emergency device according to claim 8, wherein the at least one closure element is held in a closed position by a lock and the control device is configured to trigger the emergency signal in response to the second actuation of the actuation element only if a travel speed of the vehicle has reached a threshold value, and otherwise to actuate the lock in order to allow for an adjustment of the at least one closure element out of the closed position along the opening direction into an open position, in which the at least one closure element no longer closes the storage compartment.

10. The emergency device according to claim 1, wherein the at least one emergency signal is provided for transmitting an emergency call.

11. The emergency device according to claim 1, wherein the at least one emergency signal is provided for generating an alarm that is at least one of acoustically and visually perceptible by a person in the surroundings of the vehicle.

12. The emergency device according to claim 1, wherein the at least one emergency signal is provided for influencing the current driving behavior of the vehicle.

13. The emergency device according to claim 1, wherein the emergency device for a storage compartment is provided on a front side of the vehicle.

14. A vehicle comprising an emergency device according to claim 1.

15. A method for controlling an emergency device on a vehicle, wherein by actuation of an actuation element, which is provided in the interior of a storage compartment that is closed by at least one closure element, an emergency is signaled by a person located in the closed storage compartment and at least one emergency signal is generated in response to the actuation of the actuation element,
wherein in response to an actuation of the actuation element a ventilation measure is triggered, via which additional air enters the storage compartment that is still closed by the at least one closure element.

16. (canceled)

17. The method according to claim 15, wherein in response to the at least one emergency signal at least one control signal is received from an emergency call receiving point, via which the lock is actuated for releasing the at least one closure element in order to allow for an adjustment of the at least one closure element out of a closed position along an opening direction and into an open position, in which the at least one closure element no longer closes the storage compartment.
